(19) United States
(12) Patent Application Publication
(10) Pub. No.: US 2005/0289218 A1
(43) Pub. Date: Dec. 29, 2005

(54) Method to enable remote storage utilization

(76) Inventors: Michael A. Rothman, Puyallup, WA (US); Vincent J. Zimmer, Federal Way, WA (US)

Correspondence Address: INTEL/BLAKELY, 12400 WILSHIRE BOULEVARD, SEVENTH FLOOR, LOS ANGELES, CA, 90025-1030, US

(21) Appl. No.: 10/878,470

(22) Filed: Jun. 28, 2004

(51) Int. Cl. G06F 15/16; G06F 12/00

(52) U.S. Cl. 709/203; 711/112

(57) ABSTRACT

Techniques for enabling remote storage utilization as local disk resources. A virtual disk drive comprising an emulation of a non-existent local (to a client) disk drive is facilitated via out-of-band (OOB) communications with a remote storage server in a manner that is transparent to an operating system (OS) running on the client. Storage access requests are processed in a conventional manner by the client OS, being passed as a block storage request to a firmware driver. The firmware driver redirects the request to a remote agent running on the remote storage server via a LAN microcontroller on the client using an OOB channel. A listener at the remote server routes packets to the remote agent. The remote agent performs a logical-to-physical storage block translation to map the storage request to appropriate storage blocks on the server. In one embodiment, an image of the virtual disk is stored in a single file on the server. The scheme supports diskless clients, disk mirroring and remote OS provisioning.

### FIELD OF THE INVENTION

The field of invention relates generally to computer systems and, more specifically but not exclusively relates to techniques for accessing remote storage devices that appear as local resources.

### BACKGROUND INFORMATION

A common component in most computer systems, such as a personal computer (PC), laptop computer, workstation, etc., is a disk drive, also referred to as a hard disk, a hard drive, fixed disk, or magnetic disk drive. Disk drives store data on a set of platters (the disks) that are coated with a magnetic alloy that is sensitive to electrical fields introduced by read/write heads that are scanned over the platters using a precision head actuator. As a platters spin beneath the read/write head at a high rate of speed (e.g., up to 10,000 revolutions per minute), electrical impulses are sent to the read/write head to write data in the form of binary bit streams on the magnetic surface of the platters. Reading is performed in an analogous manner, wherein magnetic field changes are detected in the magnetic platter surface as the platters spin to read back a binary bit stream.

As disk drives get progressively larger in storage capacity, the effect of a failed disk increases somewhat proportionally. For example, a modern disk drive can store 250 or more gigabytes of data—enough storage space for literally 10's of thousands of files, which is generally an order of magnitude more than the storage capacity available just a few years ago. Furthermore, it used to be fairly common to have multiple disk drives for a given PC, due in part to the desire of increasing total platform storage capacity. In most instances, the failure of one of the multiple disks was not as bad as a failure to the only disk drive for the system. However, due to the massive capacity of today's disk drives, there is rarely the need to have multiple disks for a personal workstation, such as a PC.

This leads to a return to the single disk system. Although the mean-time between failure (MTBF) advertised for modern disk drives is very impressive (e.g., 100,000 hours or more), the effective failure rate is significantly higher. This is primarily due to the way the MTBF values are determined. Obviously, the manufacturer wants to present data for its latest product, which means testing of that product can only be performed for a limited amount of time, such as 2000 hours or less (84 days). Thus, if 500 disk drives are tested for 2000 hours each, and one failure results (representing 0.2%), the MTBF is 100,000 hours. In the meantime, a significant percentage of the same drives might fail at 20,000 hours, for example. The point is that disk drives are prone to failure at much lower cumulative hours than indicated by the MTBF values.

In order to avoid the potential for catastrophic loss of data due to a disk failure, several approaches are used. For example, disk data may be backed up to a tape storage unit. Tape storage is very tedious, typically requiring management of multiple tapes, and very slow. In reality, most tape storage backup plans for individual users are never implemented with enough consistency to provide a really viable backup solution. In contrast, a good information technology (IT) department may successfully use tape storage units to backup servers, wherein the backup is typically performed on a daily basis.

Another solution is to back up the data on another disk drive, or a network storage resource. As stated above, most of today's computer systems only have a single disk drive, which generally means network backup is the only reasonable option for storing large amounts of data. Although this is a viable solution, it still requires user discipline to backup data frequently enough to the network in order to prevent a substantial amount of lost data (and thus lost work product) due to a local disk failure.

In many enterprise environments, diskless workstations are becoming more and more common. Under the diskless workstation approach, all persistent data (e.g., data for documents) is stored on a remote storage resource that is accessed via a network. One of the reasons for the popularity of this approach is that software licensing and configuration management is much easier to perform, especially for large enterprise environments. For instance, rather than hundreds or thousands of unique software configurations for individual workstations, only a few configurations need to be managed. Furthermore, the IT department can ensure that individuals don't have pirated copies or unlicensed copies of applications. In addition, management of security attacks, including protection against viruses, is more easily handled when only a few servers need to be protected, rather than 100's or thousands of individual workstations. Diskless workstations also lower capital and maintenance costs.

Although diskless workstations have their advantages, this storage approach also presents several drawbacks. Notably, there is no storage if the network is down or unable to be accessed from a current location. In addition, network disruptions may cause edits to currently-opened documents to be lost.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a computer architecture employed at a client to facilitate emulation of a non-existent local disk drive as a virtual disk having data stored on a remote storage server, according to one embodiment of the invention;

FIG. 2 is a schematic diagram of a software and firmware architecture to support virtual disk remote storage operations using the client computer architecture of FIG. 1, according to one embodiment of the invention;

FIG. 3a is a flowchart illustrating operations performed during a remote storage write process under the computer and software/firmware architectures of FIGS. 1 and 2, according to one embodiment of the invention;

FIG. 3b is a flowchart illustrating operations performed during a remote storage read process under the computer and software/firmware architectures of FIGS. 1 and 2, according to one embodiment of the invention;

FIG. 4 is a schematic diagram illustrating a logical-to-physical storage block translation, according to one embodiment of the invention;

FIG. 5a is a schematic diagram illustrating an implementation of the virtual disk scheme for operating system provisioning;

FIG. 5b is a schematic diagram illustrating an implementation of the virtual disk scheme for mirroring a local disk drive;

FIG. 6 is a flowchart illustrating operations performed in connection with installing the software and firmware components of FIG. 2;

FIG. 7 is a flowchart illustrating initialization operations that are performed in response to a system restart to initialize the firmware and software components on a client;

FIG. 8 is a flowchart illustrating operations and logic performed in connection with remote provisioning an operating system for a client; according to one embodiment of the invention; and

FIG. 9 is a schematic block diagram illustrating components of a LAN microcontroller used in the architectures of FIGS. 1 and 2, according to one embodiment of the invention.

### DETAILED DESCRIPTION

Embodiments of methods and apparatus for enabling remote storage utilization in a manner that is transparent to the local workstation are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

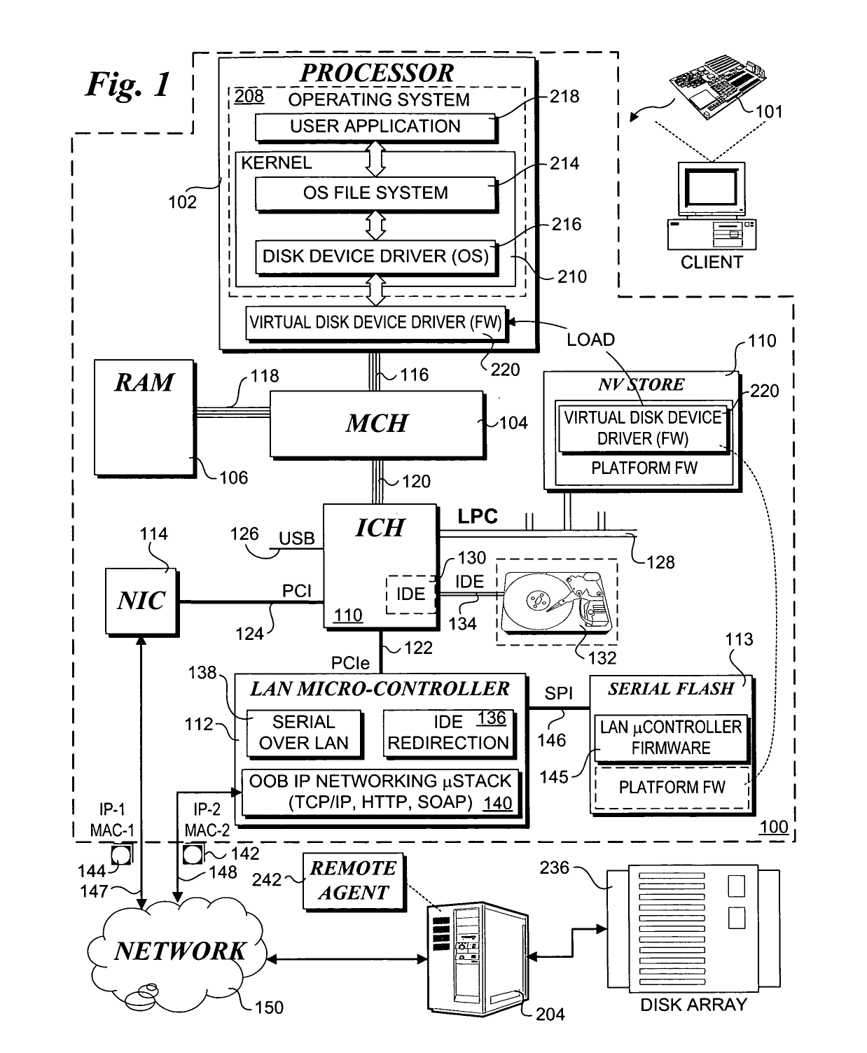

FIG. 1 shows a system architecture 100 that may be used to implement client-side aspects of the remote storage utilization embodiments discussed herein. The architecture includes various integrated circuit components mounted on motherboard or main system board 101. The illustrated components include a processor 102, a memory controller hub (MCH) 104, random access memory (RAM) 106, an input/output (I/O) controller hub (ICH) 108, a non-volatile (NV) store 110, a local area network (LAN) microcontroller (μC) 112, a serial flash chip 113, and a network interface controller 114. Processor 102 is coupled to MCH 104 via a bus 116, while MCH 104 is coupled to RAM 106 via a memory bus 118 and to ICH 108 via an I/O bus 120.

In the illustrated embodiment, ICH 108 is coupled to LAN microcontroller 112 via a peripheral component interconnect (PCI) Express (PCIe) serial interconnect 122 and to NIC 114 via a PCI bus 124. Furthermore, various devices (not shown) in addition to NIC 114 may be connected to PCI bus 124, such as one or more PCI add-on peripheral cards, including sound cards, and video cards, for example. The ICH may is also be connected to various I/O devices via corresponding interfaces and/or ports. These include a universal serial bus (USB) port 126, and a low pin count (LPC) bus 128. In one embodiment, firmware store 110 is connected to ICH 120 via LPC bus 128.

In the illustrated embodiment, ICH 108 further includes an embedded integrated drive electronics (IDE) controller 130, which, in turn, is used to control one or more IDE disk drives 132 that are connected to the controller via an IDE interface 134. IDE controllers and IDE disk drives are the most common type of disk drive and controller found in modern PCs and laptop computers. Generally, in addition to the configuration shown, a separate (from ICH 108) IDE controller may be provided for controlling an IDE disk drive.

LAN microcontroller 112 is configured to perform various operations that are facilitated via corresponding functional blocks. These include an IDE redirection block 136, a serial over LAN block 138, and an out-of-band (OOB) Internet Protocol (IP) networking microstack 140. The OOB IP networking microstack 140 supports IP networking operations that enable external devices to communicate with LAN micro-controller 112 via a conventional Ethernet connection. Accordingly, LAN micro-controller 112 also provides a LAN μC Ethernet port 142. Meanwhile, NIC 114 also provides a separate NIC Ethernet port 144.

To effectuate the operation of its various functional blocks, LAN microcontroller 112 loads firmware 145 from serial flash chip 113 and executes the firmware instructions on its built-in processor. (Details of the LAN microcontroller hardware architecture are shown in FIG. 9 and discussed below). In one embodiment, the transfer of data from serial flash chip 113 to LAN microcontroller 112 is facilitated by a Serial Peripheral Interface (SPI) 146.

To facilitate concurrent and separate usage, each of NIC Ethernet port 144 and LAN μC Ethernet port 142 have respective media access control (MAC) addresses and respective IP addresses. For simplicity, the respective MAC addresses are depicted as MAC-1 and MAC-2, while the respective IP addresses are depicted as IP-1 and IP-2. In general, NIC Ethernet port 144 and LAN μC Ethernet port 142 support respective links 147 and 148 to network 150 using conventional LAN operations and protocols.

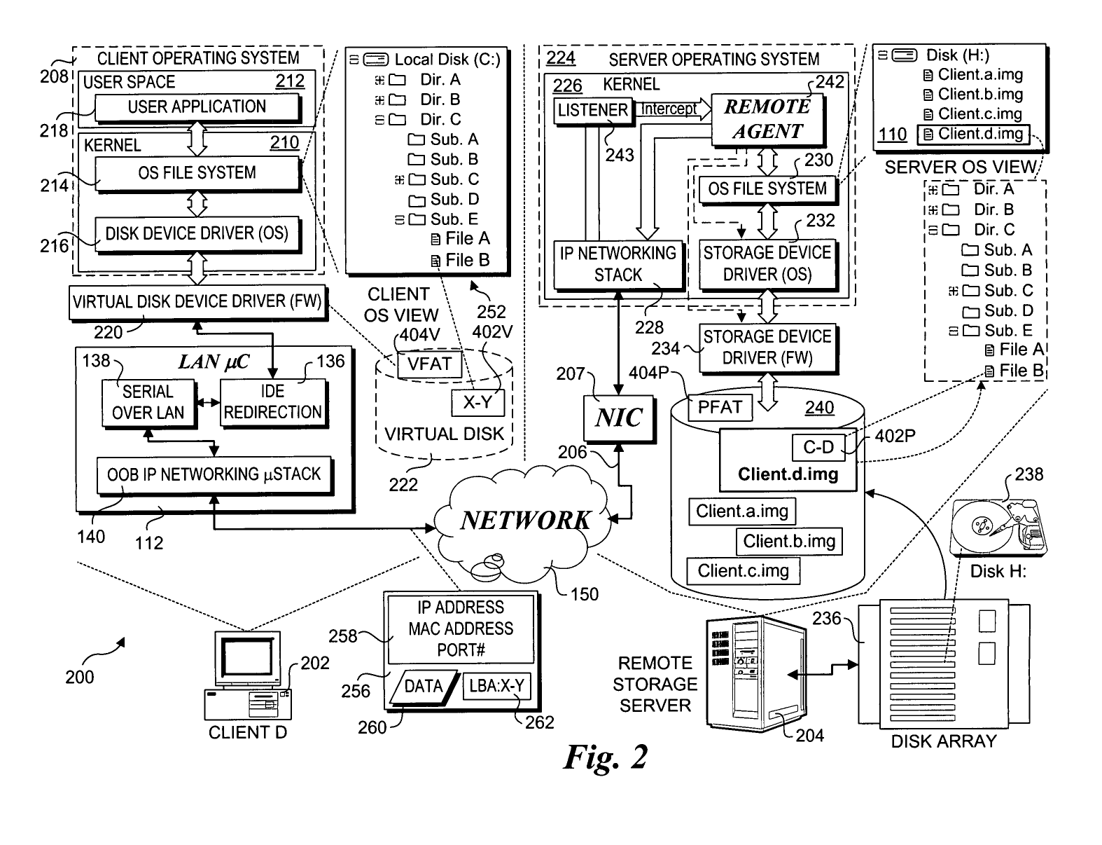

One embodiment of a software/firmware architecture 200 used to implement software and firmware aspects of specific implementations described below is shown in FIG. 2. Architecture 200 includes various software and firmware (FW) components running on a representative client 200 (Also referred to as “Client D,” and a remote storage server 204. The client and the server are linked in communication via network 150 using respective Ethernet links 148 and 206. The Ethernet link on the server side is facilitated by a NIC 207.

The client-side software components include a client operation system (OS) 208, which is loaded into RAM 106 and executed on processor 102 of client 202. The OS is generally used to run various user applications that are used by a user to generate corresponding documents for which storage is required. The illustrated operating system includes an OS kernel 210 and an OS user space 212. As will be recognized by those skilled in computer arts, the OS kernel contains the core operating system components and services, which are typically located into a protected portion of system memory. Among these core OS components is an OS file system 214 and various device drivers, including a OS disk device driver 216.

Under typical operating systems, such as Microsoft Windows operating systems, Linux variants, and UNIX variants, user applications 218 are run in user space 212, which is a separate memory space for the memory space reserved for the OS kernel. One reason for using separate memory spaces is that a corrupted user application will usually corrupt a portion of the OS user space, and not corrupt the underlying OS kernel.

Generally, two related components that operate together are used to access hardware devices, such as disk drives. These related components are embodied as device drivers, with one device driver residing in the OS kernel, while the other device driver is a firmware component. One reason for this is the lower-level firmware device driver provides a layer of abstraction that provides a consistent abstracted interface across different types of the same class of devices (in this instance, disk drives).

One of the interfaces supported by firmware device drivers is a block storage device. A block storage device interface supports data storage using logical blocks of storage. The logical blocks are mapped to an underlying physical storage scheme, such as that employed for disk drives. For example, the smallest physical unit of storage for a disk drive is a sector. In some instances, a number of sectors are combined into clusters, which represent the smallest addressable unit of storage. At the same time, the firmware disk drive device driver presents the storage for the entire disk drive as an array of blocks that can be addressed using logical block addresses (LBAs). Meanwhile, each LBA is mapped by the firmware device driver to the underlying physical storage unit (e.g., a disk sector). Thus, an OS disk device driver can merely specify a storage block or range of blocks to be accessed via corresponding LBAs, without requiring the OS-level driver to perform any of the underlying block translations, or even know such translations are being performed.

In the illustrated embodiment, the aforementioned firmware-level disk device driver operations are handled by a firmware virtual disk device driver 220. The firmware virtual disk device driver presents an interface to OS disk device driver 216 corresponding to a local logical block storage device. However, depending on the system configuration (as described below in further detail), there may or not be an actual local block storage device. Rather, a non-existent local block storage device comprising a virtual disk 222 is emulated to exist via operations performed, in part, by virtual disk device driver 220.

Virtual disk 222 operations are facilitated via a coordinated effort involving several components. The client-side components include virtual disk device driver 220, IDE redirection block 136, serial over LAN block 138, and OOB IP networking microstack 148. Meanwhile, a server-side component comprising a remote agent 224 is employed to perform server-side virtual disk operations.

Server-side components are depicted on the right-hand side of software/firmware architecture 200. The illustrated components include a server operating system 224 including an OS kernel 226. In general, server operating system 224 and client operating system 208 may comprise members of the same family of operating system, or may not. For example, in one embodiment, client OS 208 comprises a Microsoft Windows operating system, such as Windows XP, 2000, ME, 98, etc., while server operating system 224 comprises Windows Server 2000, 2003, or Windows NT. In another embodiment, the client runs a Windows family OS, while the server OS comprises a Linux-variant or a UNIX-variant. In yet another embodiment, the server OS comprises an operating system specific to a large storage system, such as a network attached storage (NAS) appliance. For illustrative purposes, the server operating system components depicted in the embodiment of FIG. 2 are illustrative of a Windows Server OS.

Accordingly, these server OS components include an IP networking stack 228, an OS file system 230, and an OS storage device driver 232. Meanwhile, the firmware-level components include a firmware storage device driver 234, which provides an abstracted interface between the server's OS-level storage device driver and the underlying physical storage device. In the illustrated embodiment, this physical storage device comprises a disk array 236 including multiple disk drives 238. The collective storage capacity of disk array 236 is depicted to server OS 224 as storage 240. Storage 240 may be generally presented as one storage volume, or multiple storage volumes. In one embodiment, disk array 236 is implemented as a RAID (redundant array of independent (or inexpensive) disks), wherein there is no direct mapping between a storage volume and the underlying disk drives 238.

In addition to the conventional server-side software and firmware components discussed, the server hosts a remote agent 242. Remote agent 242 is used to “intercept” certain storage access requests and dynamically generate appropriate storage access commands to access selected portions of storage 240. In general, remote agent 242 may be embodied as an OS kernel component (as shown), or an application running in the user space of server OS 224 (not shown). Under one embodiment of a Windows Server implementation, remote agent 242 is implemented as a Windows service. Under one embodiment of a Linux or UNIX implementation, remote agent 242 is implemented as a Linux or UNIX daemon.

In one aspect of the following embodiments, the combination of virtual disk device driver 220, IDE redirection block 136, serial over LAN block 138, OOB IP networking microstack 140 and remote agent 242 (in combination with selected conventional OS and firmware components) support implementation of a virtual storage space comprising virtual disk 222. The virtual disk appears to client operating system 208 (and thus to all of user applications 212) as a local disk drive. However, such a local disk drive does not physically exist. Rather, the data “stored” on the virtual disk are physically stored on remote storage 240.

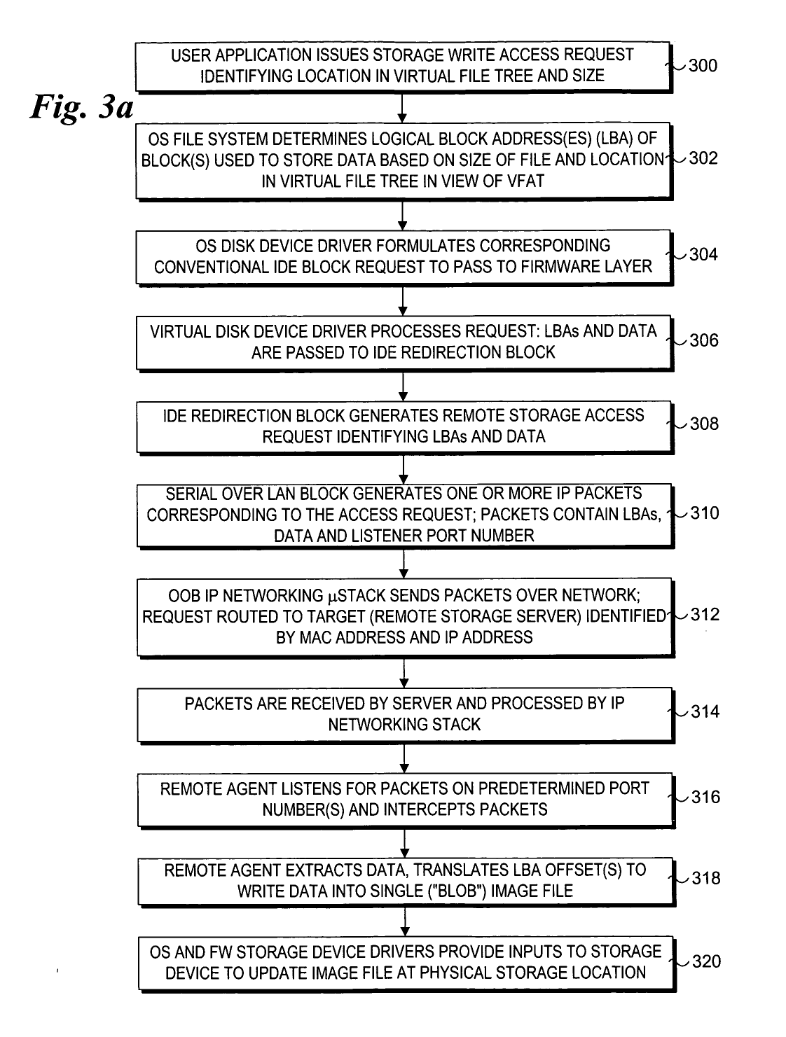

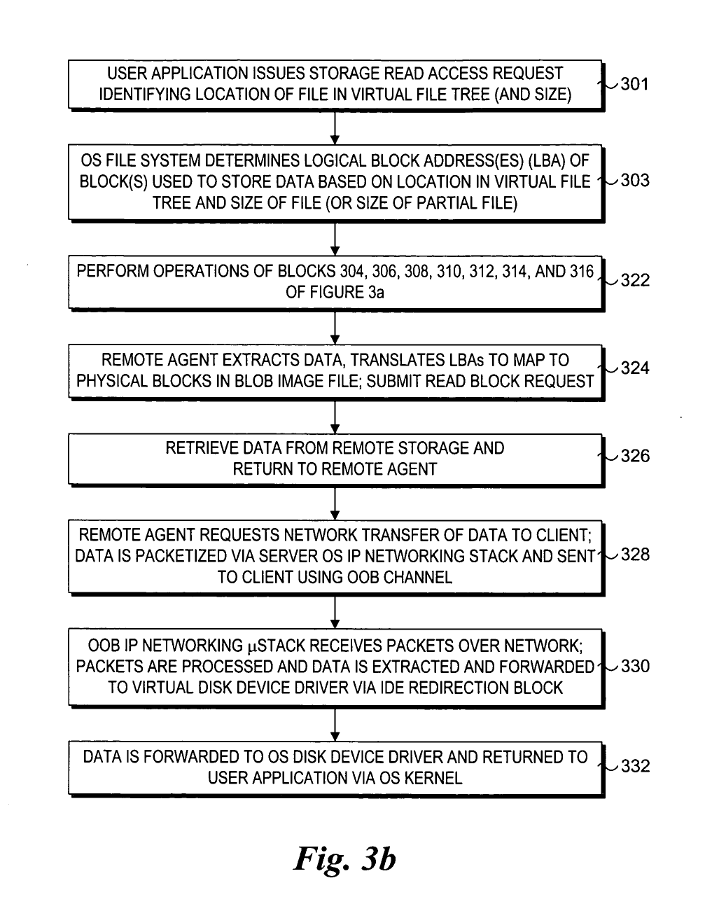

Under the virtual disk scheme, the virtual disk effectively operates in the same manner as a conventional local disk drive from the viewpoint of client OS 208. This is illustrated by way of example via the operations shown in the flowchart of FIGS. 3a and 3b, which correspond to a virtual disk write and read accesses, respectively.

With reference to FIG. 3a, the virtual disk write access process begins in a block 300, wherein a user application issues a storage write request identifying a location of a file in the virtual file tree, along with the size of the file. In cases where the storage access is to write a new file to the virtual disk, the new file will be added to the virtual file tree with the file name and location specified via the user application. A depiction of an exemplary virtual file tree 252 is shown in FIG. 2. For this example, it will be considered that a new “File B” is to be added to the virtual file tree under subdirectory “E.” Thus, the location of the new file would be specified from the tree root (in this case “Local Disk (C:)” to the subdirectory and new file name, e.g.,
Local Disk (C:)/directory C/sub-directory E/File B.

The user application's request is passed to the operating system and processed by OS file system 214. As depicted in a block 302, the OS file system determines the logical block address(es) (LBAs) of the blocks that are used to store the data based on the size of the file and location in the virtual file tree. Under a conventional Windows file system, a file allocation table (FAT) is used to map the location of files within the file tree hierarchy to the physical location on actual storage device. For each file entry in the FAT, there is a corresponding entry to the location (e.g., LBA) of the first block in which all or a first portion of the file is stored. Since Windows file systems support file fragmentation, the location of subsequent blocks are provided via a linked list mechanism. As described below, the FAT for the virtual disk is referred to as the virtual FAT or VFAT.

The information generated in block 302 is passed to OS disk device driver 216 in a block 304. The OS disk device driver formulates a corresponding conventional IDE block request and passes the request to the firmware layer. This conventional IDE block request will be identical to a request to store the file on a local disk drive that is being emulated as virtual disk 222.

In the firmware layer, the IDE block request is submitted to virtual disk device driver 220, which appears to the OS as a conventional firmware device driver. Accordingly, in one embodiment, the virtual disk device driver 220 presents an interface to the OS device driver that is similar to that employed by a conventional firmware disk drive device driver for an IDE drive. Upon receiving the IDE block request, the request is processed by virtual disk device driver 220 in a block 306. Rather than providing the request to a conventional IDE controller (which would be the normal course of action), the request is redirected to IDE redirection block 136.

In one embodiment, IDE redirection block provides an interface that corresponds to a standard IDE controller register set, thus emulating a standard IDE controller. Typically, the following pieces of information are provided to an IDE controller for a data access request: 1) whether the request is for a read or write; 2) the LBA(s) for the request; and 3) the data to be transferred (in the case of a write request). Items 1) and 2) are specified for a read access request, while no data are specified.

In response to the IDE block request, IDE redirection block generates a remote storage access request identifying the LBA(s) and data in a block 308. This information is then passed to serial over LAN block 138, which generates one or more IP packets (number of packets depending on the size of the data to be transferred) in a block 310. Also included in this information is a port number specific to virtual disk 222, as described below in further detail. Furthermore, an IP and/or MAC address for the target (e.g., remote storage server) is identified. In general, the packets can be structured to support a variety of network transport protocols, including, but not limited to TCP/IP (Transport Control Protocol/Internet Protocol) and UDP (User Datagram Protocol).

An exemplary data packet 256 is shown in FIG. 2. The data packet includes a packet header 258 containing an IP address, a MAC address, and a port number. The data packet also includes data 260 representing the data to be transferred an LBA range 262, which defines an LBA address range specifying the logical block addresses of the blocks in which the data are to be stored.

The packets are then provided to OOB IP networking microstack 140, which is employed to perform standard network communication operations in accordance with the selected transport protocol. This includes opening network link 148 and send data to remote storage server 204 via network 150. The packets are routed based on their IP address or MAC address (depending on the protocol). These operations are depicted in a block 312. In response to receiving the data packets, they are processed by IP networking stack 228 on remote storage server 204 in the conventional manner in block 314.

Prior to this operation, remote agent 242 will be loaded into the remote server's OS kernel 226 (if remote agent 242 is implemented as a kernel component), or into the OS's user space (if remote agent 242 is implemented as a user application). In accordance with the aforementioned Windows service embodiment and upon initialization by server OS 224, the remote agent service, or a separate Windows service (not shown) invokes a port “listener” 243 that “listens” for data sent to a particular port number specified by the listener. This port number is the same port number discussed above with reference to block 310. Thus, as packets are processed by IP networking stack 228, packets destined for a port number listened for by listener 243 are “intercepted” and redirected to remote agent 242 in accordance with a block 316.

In a block 318, the remote agent extracts the data contained in the data packet(s), and translates one or more LBA offsets corresponding to an LBA space in which the data are to be stored on remote storage 240 based on the LBA(s) specified in the packet(s). The data are then written to a single “blob” file in a block 320, wherein the blob file is used to store an image of virtual disk 222, and the location of the changes to the blob file are specified by the translated LBAs.

Further details of the translation process and results are illustrated in FIG. 4. During a setup process, an image file is allocated on remote storage 240 for each virtual disk. Exemplary image files shown in FIG. 4 include a Client.a.img file, a Client.b.img image file, a Client.c.img image file, and a Client.d.img image file, the later of which corresponds to virtual disk 222—the virtual disk for Client D (202). A server OS file system view 253 of these image files are shown in FIG. 2. Each image file is allocated a number of physical blocks of storage on remote storage 240, as illustrated. For simplicity, the image file for Client D (Client.d.img) is allocated 100 physical blocks, as depicted by physical blocks 400P. These physical blocks are mapped to logical blocks 400V corresponding to virtual disk 222. Also for simplicity, the address of a given block is indicated by the number shown on the block, which is also used to identify the block. For instance, block 0001 has an address of 0001.

In one embodiment, the physical blocks and the logical blocks have the same size and addressing scheme. Accordingly, a logical block can be mapped to a physical block by adding an offset that defines a difference between the base address for the logical and physical blocks. For example, the base address of logical blocks 400V is 0, while the base address for physical blocks 400P is 5000; thus the offset is 5000. Accordingly, the physical address for block 0001 is 5001—that is, the LBA of block 0001 plus the offset 5000.

As discussed above, an OS file system employs a file allocation table to map files to the location of their underlying data. In accordance the illustrated example, File B is mapped to blocks 0043, 0044 and 0045 having logical block addresses 0043, 0044 and 0045, respectively. There will be an entry in the FAT for the file, including various file attributes, such as file access type (read-only, hidden, etc.) creation date, update date, size, etc. The FAT entry will also point to the first block in which file data are located—in this instance block 0043. The location of subsequent blocks used to store file data are provided via addition FAT entries. Under Windows operating systems, the units for logical block are typically referred to as clusters, and the FAT includes cluster entries that are employed to chain together file fragments.

In order to emulate a physical disk, the FAT for the physical disk is likewise emulated. At the same time, the underlying data for the FAT is physically stored on remote storage 252. The emulated, or “virtual” FAT is represented by VFAT 404V. Meanwhile the corresponding physical FAT is represented by PFAT 404P. As depicted in FIG. 4, the location of VFAT 404V in virtual disk 222 is logical blocks 0001-0010, while the location of PFAT 404P is physical blocks 5001-5010.

Continuing with the example of FIG. 4, it is desired to specify the logical location of the file on virtual disk 222. For illustrative purposes, the logical blocks in which File B is stored are continuous, and not fragmented. Thus, the corresponding logical blocks that need to be accessed can be specified with an LBA range 402V (depicted in the Figures as range X-Y). A corresponding physical address range 402P (depicted in the Figures as range C-E) is used to identify the location of the physical blocks in which the data are (or are to be, if writing new data) stored.

From the perspective of an IDE disk drive, all data are stored on physical blocks. Thus, the IDE drive is completely agnostic to FAT tables and files. Rather, everything appears as simply data stored in selected physical blocks. In view of this, the embodiments of FIGS. 2, 3, and 4 employ a logical-to-physical block address translation to locate the physical storage blocks used to store the actual data reference by the virtual file “stored” on virtual disk 222, without concern for what type of access is being sought. In general, this is analogous to the operation of a conventional IDE controller, except that no address translation is involved.

One advantage of this scheme is that the virtual disk can have a virtual file tree 252 that can be presented to a user of client 202, while all of the underlying file system data are stored in a single blob file. Furthermore, the single blob file can be moved to another disk or even to another storage server (with appropriate configuration updates) without loss of virtual disk functionality.

A read access begins in a block 301 of FIG. 3b, wherein a user application issues a storage read access request identifying the location of the file in the virtual file tree and, optionally, the size. Depending on the particular implementation, it may be possible to request specific data within a file. In this instance, the specific data would be identified in block 301, as well. In a block 303, the OS file system determines the LBAs of the blocks used to store the data based on the location in the virtual file tree and size of the file (or partial file) using data contained in VFAT 404V. Next, as depicted in a block 322, the operations in blocks 304, 306, 308, 310, 312, 314, and 316 are performed in a manner substantially the same as that presented above with respect to the write access process.

Continuing with a block 324, upon receiving the request, which includes identification of the LBAs, the remote agent translates the LBAs with the offset value to map the logical blocks to the physical storage blocks in the blob image file. A read request of the physical blocks is then submitted to either the OS storage device driver 232 or directly to the firmware storage device driver 234, depending on the implementation. The data in the physical blocks are then retrieve from remote storage 240 and returned to the remote agent in a block 326. The remote agent then issues a request to send the data back to client D (202) in a block 328. This request is similar, in format, to a data transfer request that would normally be issued by the server OS 224, and is thus processed in a similar manner, resulting in generation one or more data packets by IP networking stack 238. The packets are then sent to the client via the LAN microcontroller's OOB channel.

Upon receipt of the packets, the OOP IP networking μstack processes the packets, the packet data is extracted, and the data is forwarded to virtual disk device driver 220 via IDE redirection block 135, as depicted in a block 330. The data is then forwarded to OS disk device driver 216 and returned to the user application via the client OS kernel in a block 332.

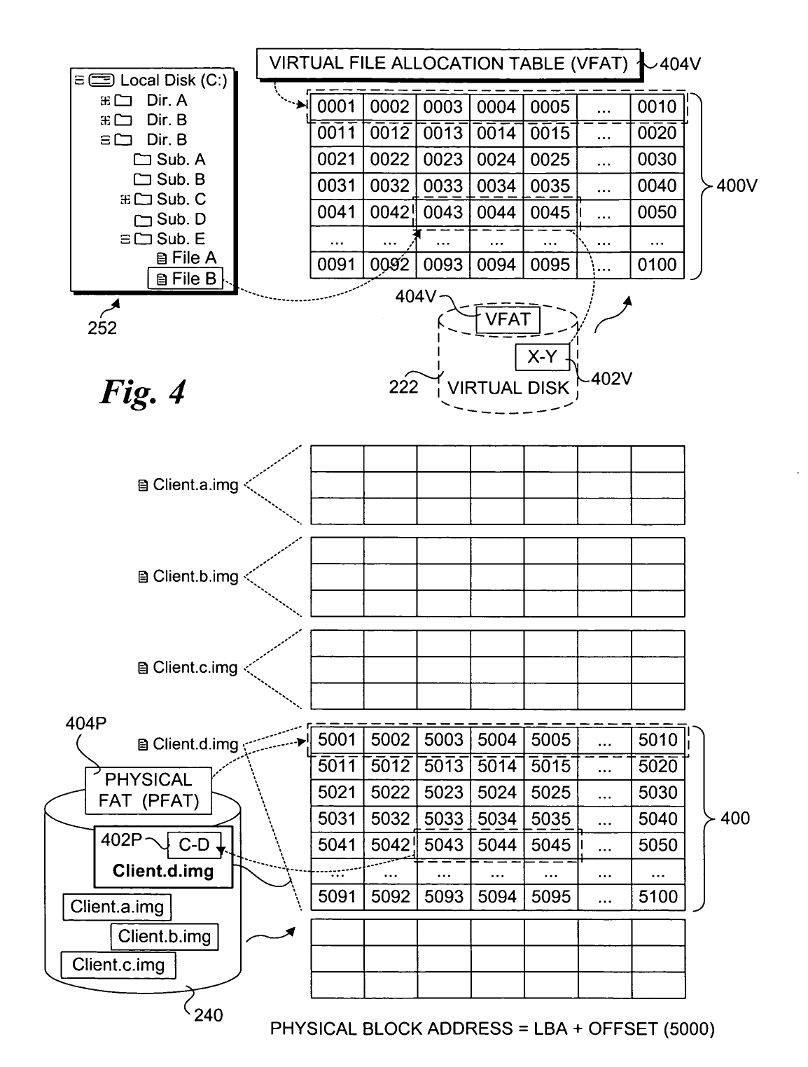

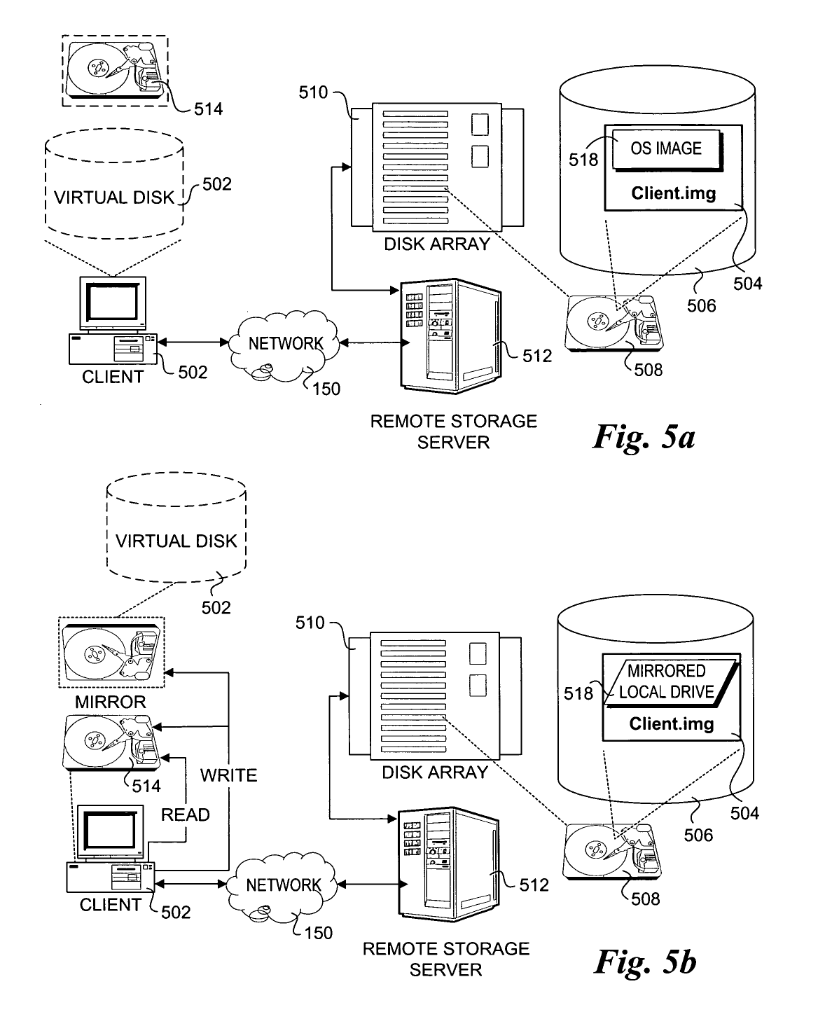

The configuration of FIG. 2 illustrates an embodiment under which a diskless client is provided with a virtual disk hosted by a remote storage server. A variant of this configuration is shown in FIG. 5a. In this configuration, a client 500 is enabled to access a virtual disk 502 using the techniques presented above. Accordingly, data corresponding to the virtual disk are physically stored as a Client.img file 504 which is store in remote storage 506. In one embodiment, the Client.img file 504 is physically stored on a disk drive 508, which is one of the disks in a disk array 510 hosted by a remote storage server 512. In another embodiment, remote storage 506 employs a RAID scheme, wherein copies of the storage blocks are replicated using one of various well-known RAID implementations. Under a RAID implementation, the RAID controller (either hardware-based or software-based) manages access to the underlying storage means (e.g., disk drives). From the operating system's viewpoint, a RAID volume comprises a storage resource that may be partitioned into one or more logical drives.

As an option, client 500 may provide a local disk drive 514 in addition to having access to virtual disk 502. The local disk drive 514 may generally comprise one of several well-known disk drive types, including, but not limited to, an IDE drive or a SCSI (Small Computer System Interface) drive.

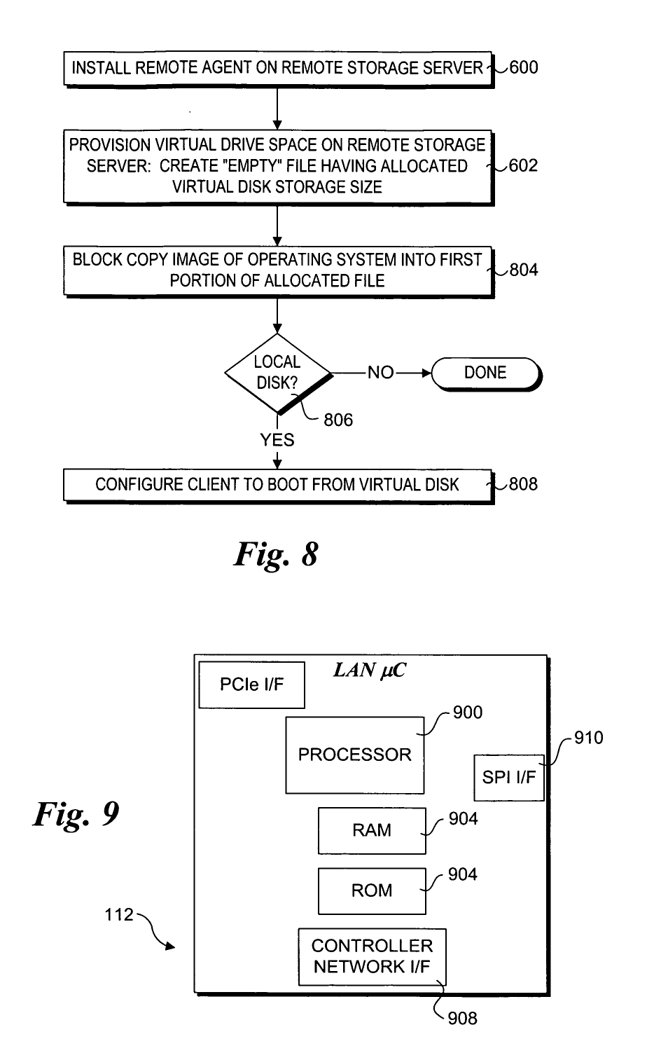

Under the embodiment of FIG. 5a, an operating system image 516 is stored in a first portion (generally) of Client.img image file 504. Furthermore, client 500 is configured to boot from virtual disk 502, whether or not a local disk drive 514 is present. Details of an operating system provisioning scheme in accordance with the embodiment of FIG. 5a are discussed below with reference to FIG. 8.

Another feature that is supported by embodiments of the virtual drive scheme is disk mirroring. For example, a disk-mirroring embodiment is shown in FIG. 5a, which includes many of the same components having common reference numbers to those FIG. 5b. In this instance, client 500 includes a local disk drive 514, which is used as the client's primary disk driver. At the same time, a virtual disk 502 hosted by remote storage server 512 is used to mirror all or a selected portion of local disk drive 514. Data corresponding to the mirrored portion of local disk drive 514 are depicted as mirrored local drive data 518.

In one embodiment, both local disk drive 514 and virtual disk 502 are configured to have the same storage capacity (e.g., same number of blocks and block size). In one embodiment, local disk drive 514 is an IDE disk drive.

In general, one of several well-known mirroring schemes may be employed. For example, under one mirroring scheme data are read from local disk drive 514, while data is written to both local disk drive 514 and virtual disk 502 in a substantially concurrent manner. In instances in which local disk drive 514 is an IDE disk drive, a single firmware component that includes the functionality of both virtual disk device driver 220 and a conventional IDE firmware disk device driver may be employed to manage mirror activities. For instance, in response to a disk write, the single firmware component issues disk write requests to both IDE controller 130 (See FIG. 1) and LAN microcontroller 112. Under another embodiment, concurrent read accesses are permitted. This enables different files from common images stored on two different storage devices to be retrieved.

In yet another embodiment, writing operations are not performed concurrently. Rather, “normal” write operations are used to write data to local disk drive 514, while copies of the local disk drive image are written periodically (e.g., once a day, once a week, etc.) to virtual disk 502 using a block copy operation. This scheme reduces the network traffic by greatly reducing the number of write operations for virtual disk 502.

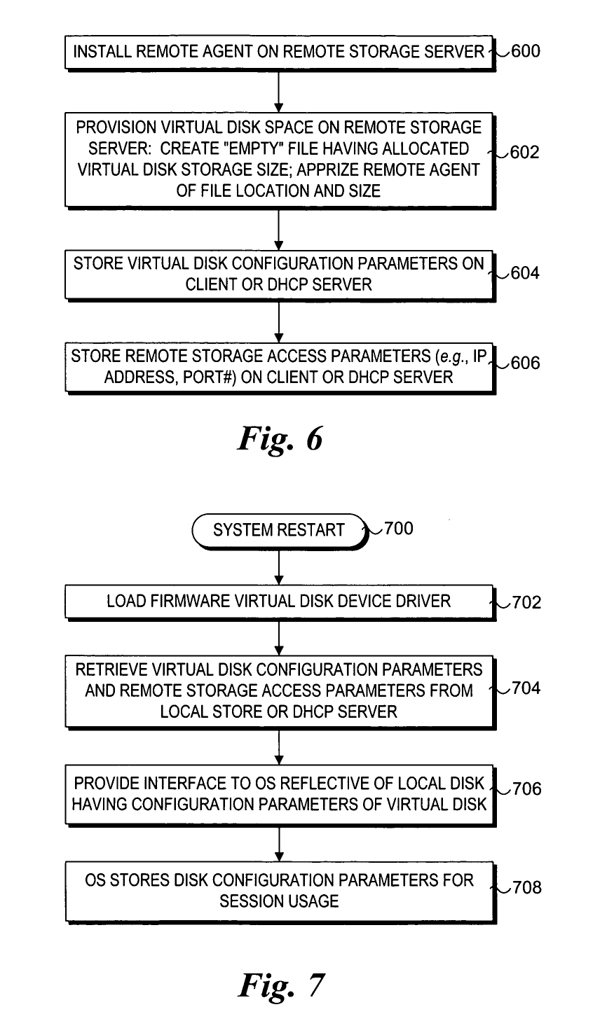

FIG. 6 shows a flowchart illustrating operations performed during one embodiment of a virtual disk setup process. The setup process begins in a block 600, wherein the remote agent is installed on the remote storage server targeted to host the virtual disk. In general, the installation process will comprise copying the remote agent to a designated directory on the remote storage server and storing configuration parameters. For example, the remote agent may be embodied as a Windows service, in case the executable file(s) for the service will be copied to a designated directory and the server's Windows registry will be updated to include parameters that are used to launch and configure the service. Similar techniques may be employed when the remote agent is embodied as a Linux or UNIX daemon. The configuration parameters will typically include the port number or numbers used by the remote agent.

In a block 602, the virtual disk space is provisioned on the remote storage server. This involves creating an “empty” file that is allocated a file size corresponding to the virtual disk capacity. The remote agent is then apprized of the file location and size. In one embodiment, this file creation process is facilitated by the remote agent. In general, the file parameters may be stored as a Windows registry entry or in a configuration file.

Next, in a block 604, the virtual disk configuration parameters are stored on one of the client or a DHCP (Dynamic Host Configuration Protocol) server. If stored on the client, the configuration parameters should be accessible to the platform firmware. Accordingly, the parameters could be stored in NV store 110 or serial flash 113. In some instances, a client contacts a DHCP server during it pre-boot operations to access network resources. Under this configuration, the configuration parameters could be stored on the DHCP server and passed to the client in conjunction with other DHCP operations.

In one embodiment, the client's system setup application is augmented to include provisions for entering the virtual disk configuration parameters. In another embodiment, the configuration parameters may be “pushed” to the client via the remote agent or via a separate application.

In addition to the virtual disk configuration parameters, remote storage access parameters are stored on the client or DHCP server in a block 606. The remote storage access parameters contain information via which the client can communicate with the remote agent. Thus, these parameters will typically include an IP address for the remote storage server and a port number corresponding to a listener port configured for the client. As with the virtual disk configuration parameters, storing the remote storage access parameters may be facilitated by an application that runs on the client, or may be facilitated via the remote agent or a separate application running on the remote storage server.

FIG. 7 shows operations that are performed on a client to setup a virtual disk. The process begins in response to a system restart, as depicted in a start block 700. Generally, the system restart may comprise a power on event, or a “warm boot” (e.g., running system reset) event.

In response to the system reset, the client begins loading and installing it's platform firmware in the conventional manner. This includes loading firmware virtual disk device driver 220 in a block 702. In general, the platform firmware may be loaded from NV store 110 or serial flash chip 113. In some embodiments, all or a portion of the platform firmware may be loaded via a network.

In a block 706 the virtual disk configuration parameters and remote storage access parameters are retrieved from a local store or DHCP server in accordance with where these parameters were stored in blocks 604 and 606 above. The virtual disk configuration parameters are used by the virtual disk device driver to emulate a local disk drive, while the remote storage access parameters are employed by LAN microcontroller 136 to redirect virtual disk access requests to remote agent 242 via network 150 and remote storage server 204. The emulation of a local disk is facilitated, in part, by providing an interface to the operating system reflective of a local disk having the virtual disk configuration parameters in a block 706. Basically, the interface is similar to a firmware interface that would be presented to the OS for accessing a local IDE drive. In fact, from the operating system's standpoint, the virtual disk actually exists as a local disk.

In general, the virtual disk configuration parameters will be handed off to the operating system in conjunction with the OS load. The OS will then store the disk configuration parameters for session usage in a block 708.

FIG. 8 shows a flowchart illustrating operations and logic performed under one embodiment of a remote operating system provisioning process. The operations of blocks 600 and 602 are performed in the manner discussed above with reference to FIG. 6 to produce an empty file, such as depicted by Client.img image file 504. A block copy of the OS image to be provisioned is then copied into a first portion of the allocated file. The block copy involves replication of a copy of the OS image that is stored on remote storage 506 on a block-by-block basis.

In a decision block 806 a determination is made to whether the client has a local disk drive. The reason for this is that the client is to boot its operating system from OS image 518, rather than an operating system that may be installed on a local disk drive. If a local disk drive is not present, the provisioning operation is complete. If a local disk is present, the client is configured to boot from the virtual disk in a block 808. Computer systems typically provide a setup program that may be accessed during pre-boot (typical) or OS runtime to modify the boot order. In this case, the virtual disk will be selected to be booted from prior to the local disk drive.

FIG. 9 shows details of a hardware architecture corresponding to one embodiment of LAN microcontroller 112. The LAN microcontroller includes a processor 900, random access memory (RAM) 902, and read-only memory (ROM) 904. The LAN microcontroller further includes multiple I/O interfaces, including a PCI Express interface 906, a controller network interface 908, and an SPI interface 910.

In general, the operations of IDE redirection block 136, serial over LAN block 138, and OOB IP networking μstack 140 may be facilitated via hardware logic and/or execution of instructions provided by LAN microcontroller firmware 145 on processor 900. Additionally, remote agent 242 may generally be embodied as sets of instructions corresponding to one or more software modules or applications. Thus, embodiments of this invention may be used as or to support software and firmware instructions executed upon some form of processing core (such as the processor of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1. A method, comprising:
emulating a local disk drive as a virtual disk hosted by a client, the virtual disk having corresponding data stored on a remote storage server accessible to the client via a network, operation of the virtual disk being transparent to an operating system running on the client such that the operating system believes the local disk drive being emulated is actually hosted by the client.

2. The method of claim 1, further comprising:
receiving a storage access request from an application hosted by the client operating system to access data that is logically stored on the virtual disk;
processing the storage access request via the client operating system to produce a logical block storage access request identifying blocks of storage on the virtual disk to be accessed;
redirecting the logical block storage access request to the remote storage server;
translating the logical block storage access request to a physical block storage access request; and
employing the physical block storage access request to access the data via the remote storage server.

3. The method of claim 2, wherein the operation of redirecting the logical block storage access request comprises:
passing the logical block storage access request to a firmware virtual disk device driver;
generating a plurality of packets containing data corresponding to the logical block storage access request; and
sending the plurality of packets over the network to the remote storage server.

4. The method of claim 3, further comprising:
launching a port listener on the remote server, the port listener configured to detect incoming packets designated for a selected port;
including information in the plurality of packets designating the selected port; and
routing packets received by the remote storage server and including information designating the selected port to a remote agent running on the remote storage server.

5. The method of claim 3, further comprising:
forwarding the logical block storage access request from the firmware virtual disk device driver to a local area network (LAN) microcontroller that is used to generate the plurality of packets; and
sending the plurality of packets over the network via the LAN microcontroller using an out-of-band channel that is transparent to the operating system running on the client.

6. The method of claim 2, wherein translating the logical block storage access request to a physical block storage access request is performed by a remote agent running on the remote storage server.

7. The method of claim 6, wherein the remote storage server runs a Microsoft Windows server operating system and the remote agent comprises a Microsoft Windows service.

8. The method of claim 6, wherein the remote storage server runs one of a Linux- or UNIX-based operating system and the remote agent comprises one of a Linux or UNIX daemon.

9. The method of claim 2, wherein the operation of translating a logical block storage access request to a physical block storage access request comprises:
translating an address of a logical storage block to an address of a corresponding physical storage block using an address offset, wherein the size of the logical and physical storage blocks are the same.

10. The method of claim 1, wherein emulation of the virtual disk comprises an emulation of a local IDE (integrated drive electronics) disk drive.

11. The method of claim 1, further comprising:
storing an image of the data logically stored on the virtual disk in a single blob file on a storage device hosted by the remote storage server, wherein the data logically stored on the virtual disk comprise multiple files stored in a directory hierarchy.

12. The method of claim 1, wherein the client runs an operating system that is a member of the Microsoft Windows family of operating systems, and the remote storage server runs an operating system that is also a member of the Microsoft Windows family of operating systems.

13. The method of claim 1, wherein the client runs an operating system that is a member of the Microsoft Windows family of operating systems, and the remote storage server runs an operating system that is not a member of the Microsoft Windows family of operating systems.

14. A method, comprising:
emulating a local disk drive as a virtual disk hosted by a client, the virtual disk providing a storage space comprising a plurality of logical storage blocks and having corresponding data stored in a plurality of physical storage blocks on a remote storage server accessible to the client via a network,
copying an operating system image into a portion of the plurality of physical storage blocks by performing a block-by-block copy operation for the operating system image; and
configuring the client to boot an operating system from the virtual disk,
wherein the client boots the operating system image stored in the single file.

15. The method of claim 14, further comprising:
allocating the plurality of physical storage blocks to a single blob file on the remote storage server, the operating system image contained within the single blob file.

16. The method of claim 15, further comprising:
re-provisioning an operating system by replacing a current operating system image contained within the single file on the remote server with a new operating system image copied into the single file.

17. The method of claim 14, further comprising:
mapping logical storage blocks corresponding to the virtual disk to the physical storage blocks using a logical-to-physical storage block mapping; and
storing information at the client identifying a boot block from which the operating system image is booted, the information identifying a logical storage block that is mapped to a physical storage block at which the operating system boot block is stored.

18. The method of claim 17, wherein the logical storage blocks are mapped to the physical storage blocks using a one-to-one address relationship with an address offset.

19. A method, comprising:
emulating a second local disk drive as a virtual disk hosted by a client having a first local disk drive, the virtual disk providing a storage space comprising a plurality of logical storage blocks and having corresponding data stored in a plurality of physical storage blocks on a remote storage server accessible to the client via a network; and
mirroring data on the first local disk drive by writing the data to the virtual disk, the data being physically stored in the plurality of physical storage blocks on the remote storage server.

20. The method of claim 19, wherein the data is mirrored by substantially concurrently writing data to the first local disk drive and the virtual disk.

21. The method of claim 20, wherein data is substantially concurrently written to the first local disk drive and the virtual disk be performing operations including:
passing a block write request from an operating system layer to a firmware layer;
generating a first block storage write request and submitting the request to the first local disk drive to write the data to the first local disk drive; and
generating a second block storage write request comprising a logical block storage write request and sending the logical block storage write request to the remote server;
translating the logical block storage write request to a physical block storage write request; and
employing the physical block storage write request to write a copy of the data to physical blocks on the remote storage server.

22. The method of claim 19, wherein communications between the client and the remote storage server are performed using an out-of-band communications channel that is transparent to an operating system running on the client.

23. A machine-readable medium to provide instructions, which if executed on a remote storage server perform operations comprising:
receiving a storage access request from a client coupled to the remote storage server via a network identifying a plurality of logical storage blocks for which data is to be written or read;
translating addresses for the plurality of logical storage blocks to addresses for corresponding physical storage blocks accessed via the remote storage server;
and performing one of generating a physical storage block write request to have data written to the physical storage blocks or generating a physical storage block read request to have data read from the physical storage blocks.

24. The machine-readable medium of claim 23, wherein a physical storage block read request is generated, the machine-readable medium to provide further instructions for performing operations comprising:
receiving data read from the physical storage blocks;
generating a network data transfer request to transfer the data received back to the client.

25. The machine-readable medium of claim 23, wherein the instructions are embodied as a Microsoft Windows service to be run on the remote storage server.

26. The machine-readable medium of claim 23, wherein the instructions are embodied as one of a Linux or UNIX daemon to be run on the remote storage server.

27. The machine-readable medium of claim 23, to provide further instructions to perform operations comprising:
listening on a network port to identify inbound network packets destined for the network port, the packets containing data corresponding to storage access requests; and
routing such network packets to be processed as storage access requests.

28. The machine-readable medium of claim 27, wherein the instructions to be perform the listening and routing operations are embodied as a Microsoft Windows service.
